(19) United States
(12) Patent Application Publication
(10) Pub. No.: US 2008/0034927 A1
(43) Pub. Date: Feb. 14, 2008

(54) Basin wrench

(75) Inventors: Brian M. Adkins, Lorain, OH (US); Steven M. Macsay, Strongsville, OH (US); Glen R. Chartier, Avon Lake, OH (US)

Correspondence Address: RANKIN, HILL, PORTER & CLARK LLP, 38210 Glenn Avenue, WILLOUGHBY, OH, 44094-7808, US

(73) Assignee: Emerson Electric Co.

(21) Appl. No.: 11/499,408

(22) Filed: Aug. 4, 2006

(51) Int. Cl. B25B 13/48; B25B 13/56; B25B 13/00

(52) U.S. Cl. 81/176.15; 81/124.2; 81/176.2

(57) ABSTRACT

A basin wrench includes a body having a hand gripping portion being configured such that a hand of a user of the basin wrench can grip the body and provide sufficient torque to rotate the body to tighten an associated basin nut. The body can include a longitudinal slot generally parallel with a longitudinal axis of the body. The basin wrench can also include an insert configured to engage an associated nut and/or an associated water shut-off valve. An additional insert can be provided to engage a strainer basket and/or be engaged by an associated wrench or rod. A method for rotating a basin nut is also provided.

### BACKGROUND

Basin nuts used to secure kitchen and vanity faucets, kitchen spray hoses, toilet ballcocks and the like usually are located in confined areas that are difficult to engage with a wrench. In recent years, plastic nuts have been used to secure faucets, ballcocks and the like. Many plastic nuts have wings or flanges to facilitate turning of the nuts by hand. In many cases, however, it still is necessary to use a wrench with such nuts to insure tightness and also to loosen nuts which may have become “frozen” in place either through over-tightening or as a result of minerals in the water.

With reference to FIG. 1, a typical vanity faucet unit 10 includes hot and cold faucets 12 and 14 each having a respective threaded shank 16 and 18 that are inserted downwardly through holes in a countertop 22. The faucet unit is clamped to the countertop by respective basin nuts 24 and 26 threaded on the shanks. For the faucet unit 10 depicted in FIG. 1, each nut (only nut 24 will be described with particularity) is plastic and includes an upper flange 28, a tubular midportion 32, and a smaller diameter lower end portion 34 which is internally threaded to receive the shank. Four angularly spaced wings 36 (the number of wings can vary) are molded integrally with the flange 28 and with the nut portions 32 and 34 and may be used to turn the nut.

Water supply lines 38 (only one is shown in FIG. 1) supply water to the faucet unit 10. In the embodiment depicted in FIG. 1, the water supply lines attach to the threaded shanks using a nut 42 (only one is shown in FIG. 1).

A known basin wrench 44 in the form of a cylindrical sleeve having notches 46 in an end can be used to turn the basin nuts 24 or 26. In instances where the water supply line, for example water supply line 38, has already been attached to the threaded shank, for example threaded shank 18, the known basin wrench 44 cannot be used to rotate the basin nut 26 because there is no way for the known basin wrench 44 to fit around the water supply line unless the water supply line is removed from the threaded shank 18 or cut in a manner so that the water supply line can be fed through one of the ends of the sleeve. This limits the instances where the known wrench can be used.

### SUMMARY

A basin wrench includes a body having a longitudinal axis, a slot generally parallel with the longitudinal axis of the body, a first opening disposed at a first end of the body, and a hand gripping portion spaced from the first opening. The hand gripping portion is configured such that a hand of the user of the basin wrench can grip the body and provide sufficient torque to rotate the body to tighten or untighten an associated basin nut.

A method for rotating a basin nut includes the following steps: passing a water supply line through a longitudinal slot in a basin wrench; engaging a basin nut with the basin wrench; grasping the basin wrench with one's hand; and rotating the basin wrench with one's hand.

The basin wrench can also include an insert selectively received in an opening. The insert is configured to engage at least one of a supply line nut and a supply line shut-off valve. An additional insert can be provided to engage a strainer basket and also be engaged by a wrench or a rod.

A basin wrench system includes an elongated main body and a removable adapter member. The elongated main body defines a rotational axis. The main body includes an adaptable portion and a hand gripping portion spaced from the adaptable portion along the rotational axis. The hand gripping portion is configured such that a hand of a user of the basin wrench can grip the hand gripping portion and rotate the adaptable portion of the main body about the rotational axis. The removable adapter member selectively connects with the adaptable portion of the main body. The adapter member is configured to operatively engage an associated component selected from a group comprising at least one of a basin nut, a water supply line nut, a water supply line shut-off valve and a strainer basket.

### BRIEF DESCRIPTION OF THE DRAWINGS

FIG. 1 is an elevational partial cross-sectional view of a typical vanity faucet depicting one of the basin nuts of the faucet being engaged by a known basin wrench (only a portion of which is shown in FIG. 1).

FIG. 2 is a perspective view of the known basin wrench.

FIG. 3 is a perspective view of a novel basin wrench.

FIG. 4 is an elevation view of the basin wrench of FIG. 3 showing a longitudinal slot in the basin wrench and a first insert inserted into a wrench body in a first orientation.

FIG. 5 is an exploded perspective view, opposite the view depicted in FIG. 3, of the basin wrench of FIG. 3.

FIG. 6 is a view taken at line 6-6 in FIG. 4.

FIG. 7 is a cross-sectional view taken at line 7-7 of FIG. 11.

FIG. 8 is an elevation view of the basin wrench of FIG. 3 similar to the view in FIG. 4 showing the first insert inserted into the wrench body in a second orientation.

FIG. 9 is a perspective view, opposite the view of FIG. 3, of the basin wrench of FIG. 3, with an insert in a position to engage an oval supply line shut-off valve.

FIG. 10 is a view taken at line 10-10 in FIG. 4.

FIG. 11 is an elevation view of the basin wrench of FIG. 3 rotated 90° clockwise about its rotational axis from the view shown in FIG. 4.

FIG. 12 is an elevation view of the basin wrench of FIG. 3 rotated 90° clockwise about its rotational axis from the view depicted in FIG. 11.

FIG. 13 is an exploded elevation view of the basin wrench of FIG. 3 similar to the view depicted in FIG. 4.

FIG. 14 is a perspective exploded view of the basin wrench similar to FIG. 3.

### DETAILED DESCRIPTION

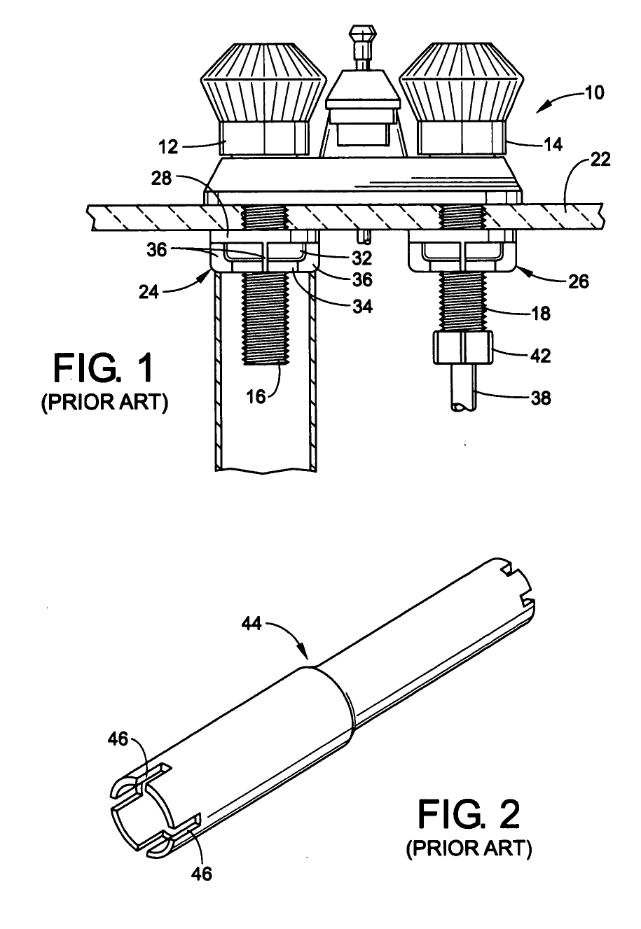

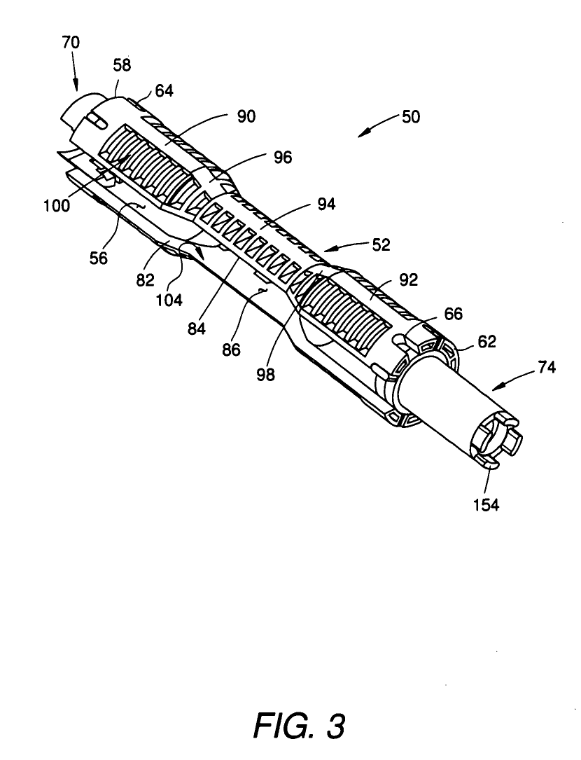

With reference to FIG. 3, a basin wrench 50 is useful for rotating basin nuts, for example, basin nuts 24 and 26 depicted in FIG. 1, to attach a faucet unit to a countertop. The basin wrench 50 is also useful in many other applications for example tightening ⅞″ supply line nuts, plastic wing supply nuts, 1″ supply line nuts (and nuts having other, for example metric, dimensions) and supply line shut-off valves. Accordingly, the invention should not be limited to only a wrench for loosening basin nuts, but instead should be construed broadly. In the depicted embodiment, the basin wrench 50 is made from a molded rigid plastic material; however, other materials, e.g. metal, composites, and the like can also be used.

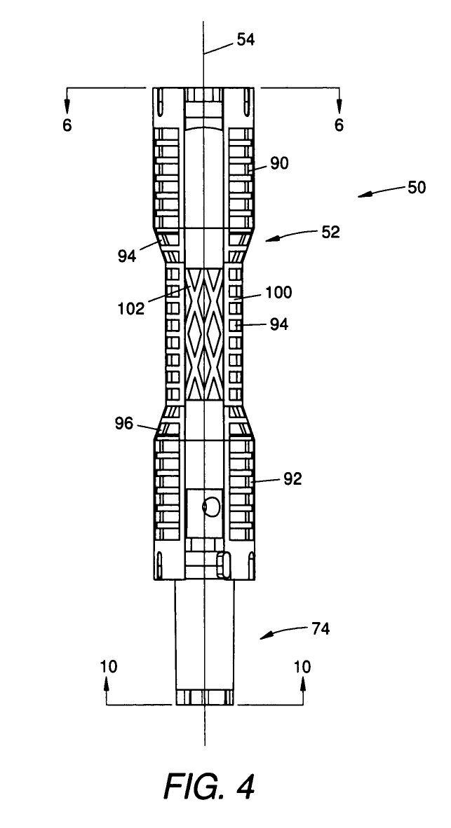

According to the embodiment depicted in FIG. 3, the basin wrench 50 generally includes an elongated wrench body 52 having a generally hour-glass configuration that is generally axially symmetric about a longitudinal axis 54 (FIG. 4), which is also the rotational axis of the basin wrench (described more fully below). The wrench body 52 can be described as generally hollow to define an interior portion 56 that can receive a water supply line, for example the water supply line 38 depicted in FIG. 1. The wrench body 52 includes a first end 58 and a second end 62. In the depicted embodiment, the ends 58 and 62 of the wrench body 52 are adaptable to operatively engage many different components including a basin nut, a water supply line nut, a water supply line shut-off valve and a strainer basket. A plurality of notches 64 extend generally parallel to the longitudinal axis 54 from the first end 58 towards the second end 62. Similarly, a plurality of second notches 66 extend generally parallel to the longitudinal axis 54 from the second end 62 of the body 52 towards the first end 58.

The slots 64 and 66 are configured to engage basin nuts, an example of which being the basin nuts 24 and 26 depicted in FIG. 1. The slots 64 and 66 are appropriately spaced about the circumference, i.e. angularly spaced from one another, so that the slots can engage two-winged nuts, three-winged nuts, four-winged nuts, and six-winged nuts depending on which end 58 or 62 of the wrench body 52 is used to engage the basin nut.

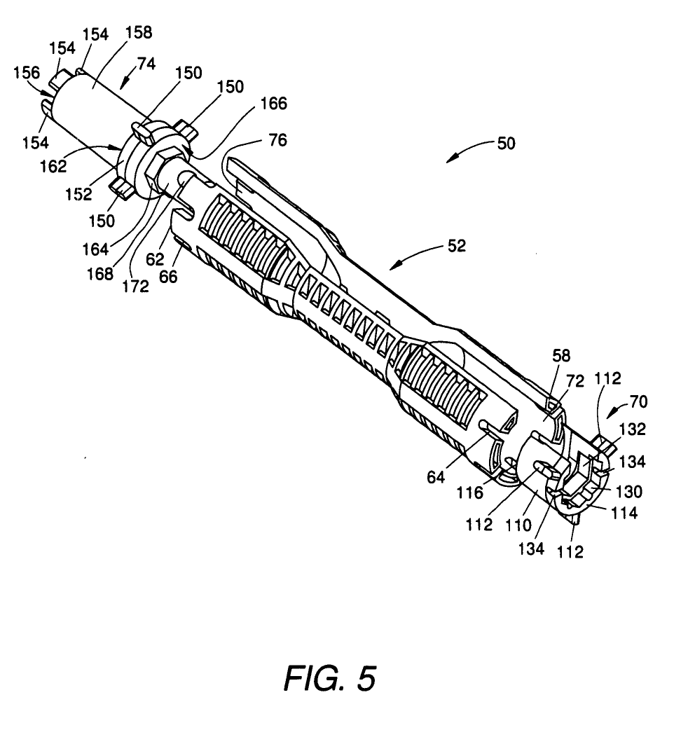

A first insert 70 is selectively received inside a first opening 72 (more clearly seen in FIG. 5) in the first end 58 of the wrench body 52. A second insert 74 is received inside a second opening 76 (more clearly seen in FIG. 5) of the second end 62 of the wrench body 52. Each insert 70 and 74 can be received by the wrench body in a first orientation and a second orientation, which will be described in more detail below. The inserts 70 and 72 provide adaptability to the wrench 50 allowing it to be used to engage many different components found typically in the plumbing in kitchens, bathrooms and the like.

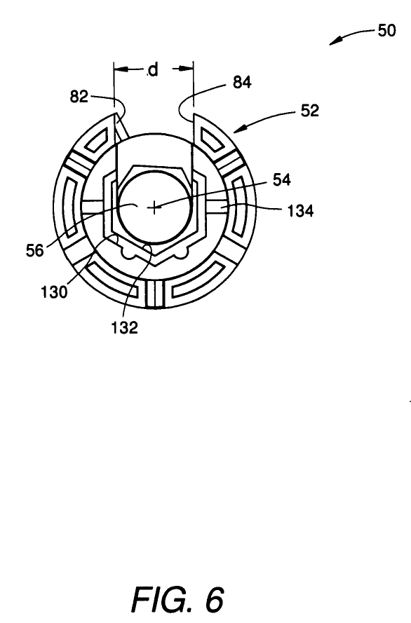

The wrench body 52 has a general C-shaped configuration (or backwards C-shaped configuration) in a cross section taken normal to the longitudinal axis 54 (see FIG. 6). With reference back to FIG. 3, the wrench body 52 includes a first longitudinal edge 82 and a second longitudinal edge 84 that are spaced from one another to define a longitudinal slot 86 between them. The slot 86 can be described as a removed segment from a circular side wall when viewed in a cross section taken normal to the rotational axis 54. The distance d (FIG. 6) between the first longitudinal edge 82 and the second longitudinal edge 84 is great enough so that a water supply line, such as the water supply line 38 in FIG. 1, can be received through the slot 86 so that the supply line resides in the hollow interior portion 56 of the wrench body 52 when the wrench 50 is used to tighten or loosen a basin nut (or other component).

In the embodiment depicted, the wrench body 52 includes a first larger outside diameter section 90 that extends generally from the first end 58 of the wrench body towards the second end 62 and a second larger diameter section 92 that extends generally from the second end 62 of the wrench body towards the first end 58. A hand gripping section 94 is generally centrally disposed between the first enlarged section 90 and the second enlarged section 92. A first tapered section 96 provides a transition between the first enlarged section 90 and the hand gripping section 94. A second tapered section 98 provides a transition between the second enlarged section 92 and the hand gripping section 94. The enlarged sections 90 and 92 are provided to engage a basin nut and/or to receive a respective insert. The wrench body 52 narrows at the hand gripping section 94 to provide a smaller exterior diameter to facilitate easier gripping of the wrench 50 to tighten and/or loosen basin nuts (as well as other items) by simply rotating the wrench 50 about its rotational axis 54. The hand gripping section 94 is spaced from the respective ends of the wrench body 52 along the longitudinal axis 54 so that the ends of the wrench body can fit into the confined areas where basin nuts, kitchen spray hoses, toilet ballcocks and the like typically reside while providing an area for the user of the wrench 50 to grip and turn the wrench. The hand gripping section 94 in the depicted embodiment is also long enough, as measured parallel to the longitudinal axis, so that at least a majority of one's hand is accommodated by the hand gripping section.

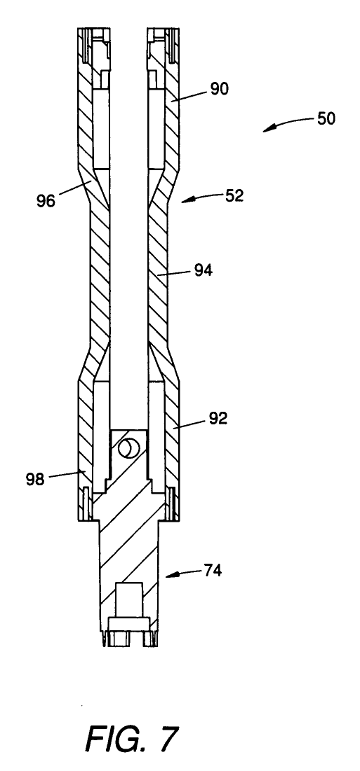

As more clearly seen in FIG. 7, the body 52 is thicker (taken in a cross section parallel with the longitudinal axis 54) in the area of the hand gripping section 94 as compared to the enlarged sections 90 and 92. Accordingly the hand gripping section 94 can accommodate the ring compressive force exerted by the hand of the user as he rotates the wrench 50 about its rotational axis 54. Such a configuration is desirable since the body 52 includes the longitudinal slot 86 whereby the compressive force applied by one's hand is not carried through the removed segment, i.e. the slot 86, of the circular side wall.

With reference back to FIG. 3, a plurality of circumferential ribs 100 are formed on an exterior surface of the wrench body 52 to provide additional rigidity to the body while lessening the amount of material from which the wrench body is made. The exterior ribs 100 are disposed in the larger diameter sections 90 and 92, the tapered sections 96 and 98 and the hand gripping section 94 of the wrench body 52 to reinforce the body when a compressive force is being exerted around the C-shaped wrench body. The ribs can also carry torsional forces that arise from tightening or loosening a nut, or similar component. The exterior ribs 100 also limit the amount of surface area that can become soiled so that one's hand does not slip when one attempts to rotate the wrench 50.

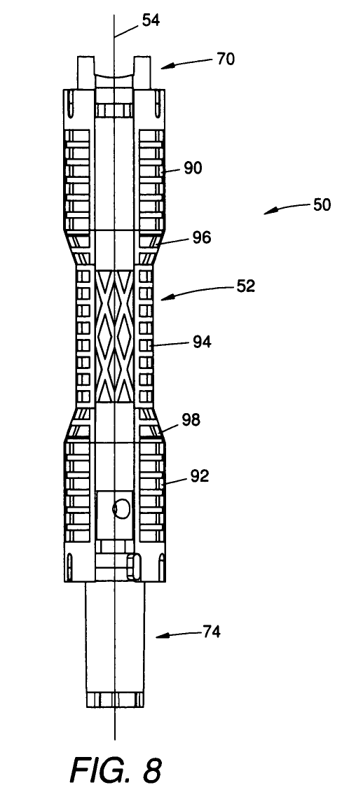

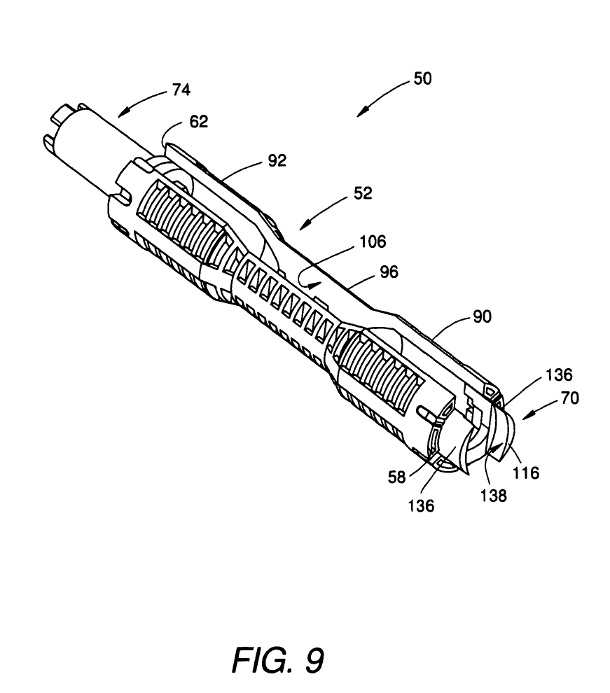

As more clearly seen in FIG. 8, internal ribs 102 can also be provided in the hand gripping section 94. In the depicted embodiment, the internal ribs 102 intersect one another and run at an angle to the longitudinal axis 54 of the wrench 50. The internal ribs 102 generally terminate at a first inner planar surface 104 (FIG. 3) and a second inner planar surface 106 (FIG. 9). These planar surfaces 104 and 106 extend from the longitudinal edges 82 and 84 into the interior portion 56 of the wrench body 52 in the hand gripping section 90 to also add to the thickness of the body 52 in the hand gripping section. The ribs 102 can provide structural integrity to the hand gripping section as well as lessening the amount of material to form the hand gripping section.

With reference to FIG. 5, the first insert 70 is configured to engage ⅞ inch hex supply line nuts, plastic wing supply line nuts, one inch hex basin nuts, and oval handle supply line shut-off valves. If desired, the first insert 70 can be altered to engage nuts having metric dimensions. In the depicted embodiment, the first insert 70 is made of a rigid material, for example, metal and/or plastic. The first insert 70 includes a substantially C-shaped side wall, which can also be referred to as a first insert body 110. A plurality of tabs 112 radially extend from an outer surface of the body 110. In the depicted embodiment, the radial tabs 112 are spaced 120 degrees apart from one another around a periphery of the first insert. In the depicted embodiment, three radial tabs 112 are selectively received in the slots 64 formed in the first end 58 of the wrench body 52. When the radial tabs 112 are received in the slots 64 of the wrench body 52, the first insert 70 is fixed so that it rotates with the wrench body 52 as one rotates the wrench 50. If desired, the first insert 70 can be received in another manner that allows the first insert to be fixed with respect to the wrench body 52. Moreover, the first insert 70, or adapter member, can connect with the wrench main body in another manner that allows the adapter member to rotate with the wrench body. As an example, the first insert 70 can have a non-circular exterior shape that is received in a complementary shaped opening in the wrench body 52 to fix the first insert with respect to the wrench body. In the depicted embodiment, the radial tabs 112 are disposed adjacent a first end 114 of the first insert body 110. The insert body also includes a second end 116 opposite the first end.

More specifically with regard to the depicted embodiment, the first insert body 110 includes a first set of internal flattened surfaces 130 that are configured to engage a one inch hex basin nut. With reference to FIG. 5, the first set of flattened surfaces 130 is disposed adjacent the first end 114 of the first insert body 110. The first insert body 110 also includes a second set of internal flattened surfaces 132 that are configured to engage a ⅛ inch hex supply line nut. The second set of flattened surfaces 132 is spaced from the first end 114 towards the second end 116 of the insert body 110. The configuration and dimensions of the flattened surfaces can be changed where the insert would be used to engage nuts having different, e.g. metric, dimensions. The first insert body 110 also includes a pair of notches 134 formed in the first end 114 extending generally parallel to the rotational axis 54 of the wrench body 52 (when the first insert 70 is received in the wrench body) towards the second end 116. These notches 134 are configured to engage the wings of a plastic wing supply line nut similar to the plastic supply line nut 24 depicted in FIG. 1.

As more clearly seen in FIG. 9, the first insert body 110 also includes a pair of extensions 136 each having a curved inner surface 138 for engaging an oval handle supply line shut-off valve. Accordingly, the insert 70 can be inserted into the first opening 72 of the wrench body 52 (or connected to the wrench body) in a first orientation to allow for engagement with a ⅞ inch hex supply line nut, a plastic wing supply line nut or a one inch hex basin nut (see FIG. 4). When reversed and inserted into the wrench body 52, i.e. in a second orientation such as that disclosed in FIG. 9, the first insert 70 can engage an oval handle supply line shut-off valve.

The second insert 74 is configured to be received inside the second opening 76 of the wrench body 52. With reference to FIG. 5, the second insert 74 includes a plurality of radial tabs 150 that radiate from a periphery of a cylindrical portion 152. The radial tabs 150 are configured to be received inside the slots 66 formed in the second end 62 of the wrench body 52. The slots 66 are angularly spaced from one another differently than the slots 64 in the first end 58 of the wrench body 52 so that the first insert 70 is not mistakenly inserted into the second opening 76 of the body 50 and vice versa. The slots 64 are angularly spaced from one another differently than the slots 66 also so that the slots at one end are configured to engage a basin nut having a first configuration and the slots at the other end are configured to engage a basin nut having a second configuration. The second insert 76 can attach to the second end 62 of the wrench body 52 in other manners, for example, the second end of the wrench body can have a polygonal or non-circular opening that matches a polygonal or non-circular configuration that can be formed on the second insert 76, or the second insert, or adapter member, can connect to the wrench body 52 without being received in the second opening.

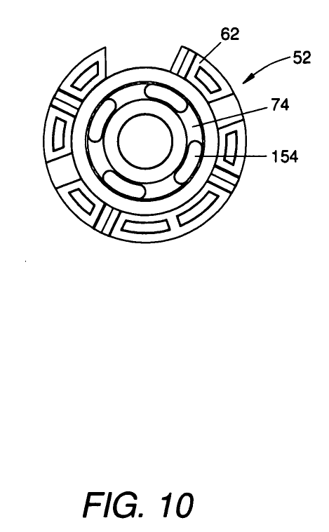

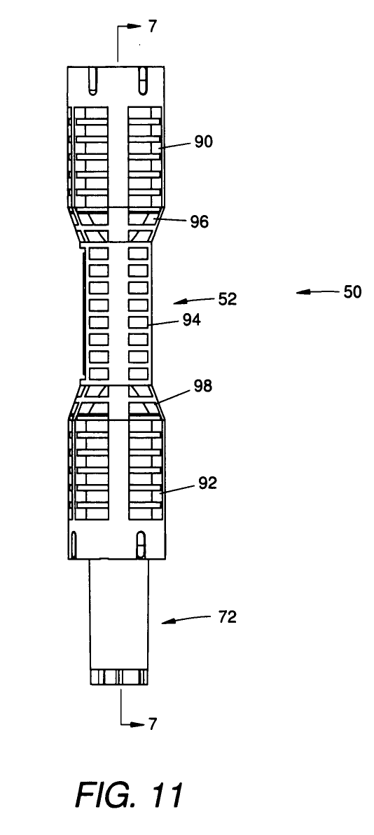

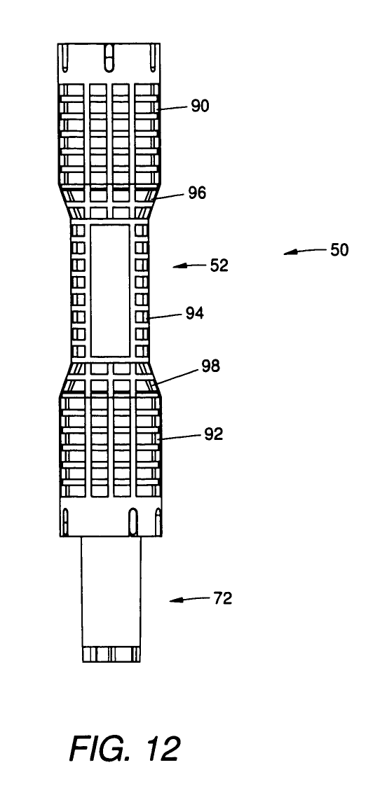

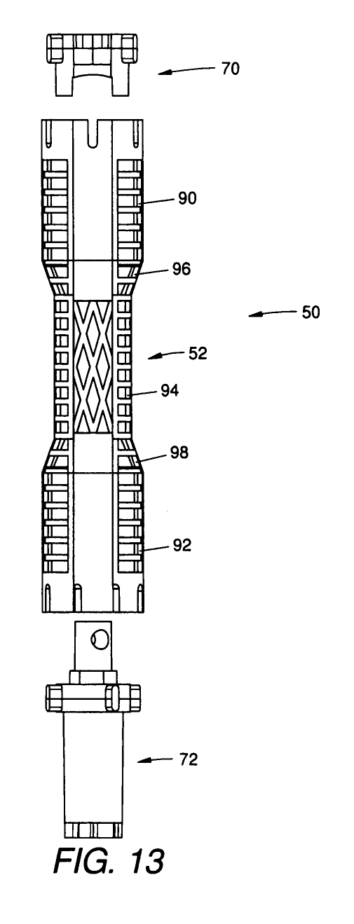

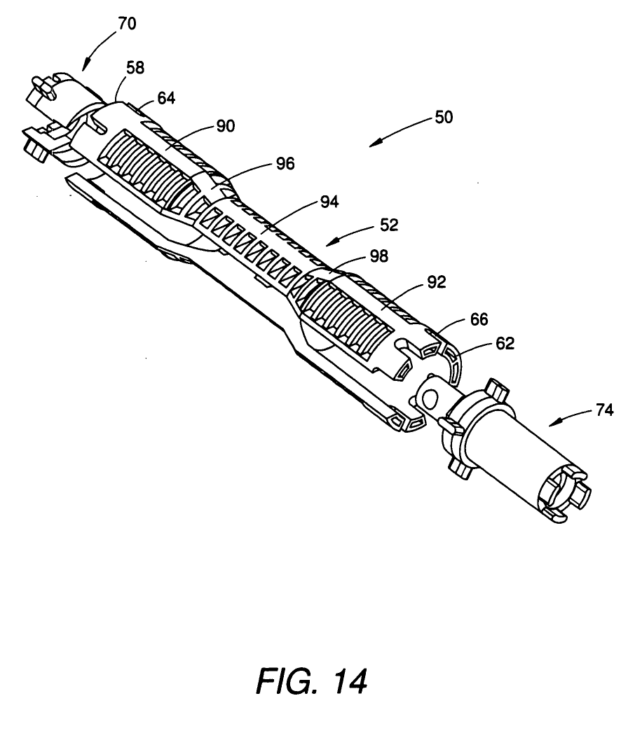

With continued reference to FIG. 5, the second insert 76 also includes a plurality of axially extending tabs 154 that extend from a generally planar end surface 156 of a smaller diameter section 158 (as compared to the aforementioned cylindrical portion 152). The smaller diameter section 158 extends from a first circular face 162 of the cylindrical portion 152 and is aligned coaxial therewith. In the depicted embodiment, four axially extending tabs 154 extend from the end surface 156 and are angularly spaced approximately 90° on center from one another (see FIG. 10). The tabs 154 are spaced from one another in a manner such that the second insert tool 76 can engage a strainer basket, which is typically used in a kitchen sink.

The second insert 74 also includes an integral hexagonal boss 164 extending from a second circular face 166 that is located opposite the first circular face 162. The hexagonal boss 164 is configured to be received by an associated wrench so that, if desired, the wrench body 52 (and the inserts 70 and 72) can be rotated using the wrench. A cylindrical boss 168 extends coaxially from the hexagonal boss 164 and includes a radial through bore 172. The radial through bore 172 can receive a bar that can be used as a tool for rotating the basin wrench. If the insert 74 is used to provide additional torque via a wrench or bar, the second insert 74 is inserted into the wrench body 52 in a first orientation where the hexagonal boss 164 and the cylindrical boss 168 extend axially from the second end of the body. The second insert 74 can be inserted in a second orientation (see FIG. 3) where the tabs 154 extend from the second end 62 of the wrench body 52 where the wrench 50 is used to engage a strainer basket.

The second insert 74 can also be used independently of the basin wrench 50. In such an instance, the second insert 74 would be removed from in wrench body 52 and the axially extending tabs 154 would be inserted into openings in a strainer basket. The hexagonal boss 164 and/or the radial through bore 172 would be engaged by a tool, e.g. a conventional wrench or bar, to rotate the second insert 74, and in turn, the strainer basket.

The basin wrench has been described with reference to particular embodiments. Modifications and alterations will occur to those upon reading and understanding the preceding detailed description. For example, if desired the ends of the basin wrench can be formed similar to one of the ends of one of the inserts. Accordingly, the invention is not limited to only those embodiments that were described and the alternatives described with reference to those embodiments. Instead, the invention is broadly defined by the appended claims and the equivalents thereof.

1. A basin wrench system comprising:
a plastic elongated main body defining a rotational axis, the main body including an adaptable portion, a first longitudinal slot extending from a first end to a second end and a hand gripping portion spaced from the adaptable portion along the rotational axis, the hand gripping portion being configured such that a hand of a user can grip the hand gripping portion and rotate the adaptable portion of the main body about the rotational axis; and a metal removable adapter member selectively connected with the adaptable portion of the main body, the removable adapter member including a second slot extending from a first end to a second end of the member and the adapter member being configured to operatively engage an associated component selected from a group comprising at least one of a basin nut, a water supply line nut, and a water supply line shut-off valve.

2. The system of claim 1, wherein the adaptable portion includes a first end of the main body.

3. The system of claim 1, wherein the removable adapter member is configured to connect with the adaptable portion of the main body in a first orientation where the member is configured to operatively engage at least two different sized nuts and a second orientation where the member is configured to operatively engage a water shut-off valve, wherein the removable adapter member is rotated about an axis that is perpendicular to the rotational axis to change from the first orientation to the second orientation.

4. (canceled)

5. The system of claim 1 wherein the first slot is generally parallel with the rotational axis of the main body.

6. (canceled)

7. The system of claim 1, wherein the second slot is generally parallel with the rotational axis of the main body.

8. In combination:
a elongated main body defining a rotational axis, the main body including an adaptable end portion and a hand gripping portion spaced from the adaptable end portion along the rotational axis, the adaptable end portion being configured to engage three-winged nuts and six-winged nuts; and
a removable adapter member configured to selectively connect with the adaptable end portion of the main body, the adapter member being configured to operatively engage an associated component selected from a group comprising at least one of a basin nut, a water supply line nut, and a water supply line shut-off valve.

9-10. (canceled)

11. A basin wrench comprising:
a body having a longitudinal axis, a slot extending through the body from a first end to a second end and generally parallel with the longitudinal axis of the body, a first opening disposed at the first end of the body, a hand gripping portion spaced from the first opening, and a plurality of circumferential ribs extending from an outer surface of the body, the hand gripping portion being configured such that a hand of a user of the basin wrench can grip the hand gripping portion and provide sufficient torque to rotate the body to tighten or loosen an associated basin nut.

12. The wrench of claim 11, wherein the slot is configured to fit over an associated faucet supply line.

13. The wrench of claim 11, wherein the hand gripping portion has an outer diameter that is less than an outer diameter of the first end of the body.

14. The wrench of claim 11, further comprising an insert configured to be received in the opening, the insert being configured to engage an associated nut.

15. The wrench of claim 14, wherein the insert is configured to engage an associated nut having a first configuration and an associated nut having a second configuration.

16. The wrench of claim 15, wherein the insert is configured to engage an associated plastic wing supply line nut.

17. The wrench of claim 14, wherein the insert is configured to engage an associated supply line shut-off.

18. The wrench of claim 11, wherein the body includes a second opening disposed at the second end of the body, the second opening being configured to receive an insert.

19. The wrench of claim 11, wherein the hand gripping portion of the body is thicker in a cross section taken parallel to the longitudinal axis of the body as compared to a portion of the body adjacent the first end.

20.

21. The wrench of claim 11, wherein the elongated body has a general hour glass configuration and the hand gripping portion is centrally located between the first end and the second end of the body.

22-24. (canceled)

25. A basin wrench comprising: an elongated body including a first opening at a first end, a second opening at a second end, a longitudinal slot extending from the first end to the second end and a hand gripping section spaced from the first end and the second end, the hand gripping section configured to be gripped by a hand of an associated user of the wrench such that the wrench can be rotated by hand about a rotational axis of the body, the first end being configured to engage a wing nut having a first configuration and the second end being configured to engage a wing nut having a second configuration;
first insert received in the first opening, the first insert being configured to engage at least one of an associated supply line nut, an associated basin nut and an associated supply line shut-off valve; and
a second insert received in the second opening, the second insert being configured to engage a strainer basket.

26. (canceled)

27. The basin wrench of claim 25, wherein the first insert is configured to engage an associated nut having a first configuration and an associated nut having a second configuration when the first insert is received in the first opening in a first orientation.

28. The basin wrench of claim 27, wherein the first insert is configured to engage the associated supply line shut-off valve when received in the first opening in a second orientation.

29. (canceled)

30. The basin wrench of claim 25, wherein the second insert includes a hexagonal boss.

31. A basin wrench comprising:
an elongated body including an opening at a first end, a longitudinal slot extending from the first end to a second end and a hand gripping section spaced from the first end and the second end, the hand gripping section configured to be gripped by a hand of an associated user of the wrench such that the wrench can be rotated by hand about a rotational axis of the body, the first end being configured to engage a wing nut; and
an insert received in the opening, wherein the insert can be received in the opening in a first orientation and a second orientation, in the first orientation the insert being configured to engage at least two different nuts having different dimensions and in the second orientation the insert being configured to engage a water shut-off valve, wherein the insert is removed then reversed and then inserted back into the opening to change from the first orientation to the second orientation and vice versa.

32. The system of claim 1, wherein the main body further comprises exterior ribs that follow a radius about the rotational axis.
